(19) United States
(12) Patent Application Publication
(10) Pub. No.: US 2021/0347327 A1
(43) Pub. Date: Nov. 11, 2021

(54) SAFETY CUTTING DEVICES FOR VEHICLE SEAT BELTS

(71) Applicants: Paulette Counts, Miland, MI (US); Curt Tucker, Saginaw, MI (US)

(72) Inventors: Paulette Counts, Miland, MI (US); Curt Tucker, Saginaw, MI (US)

(21) Appl. No.: 16/867,864

(22) Filed: May 6, 2020

(51) Int. Cl. B60R 22/32; B26B 25/00

(52) U.S. Cl. CPC B60R 22/32; B60R 2022/328; B26B 25/007

(57) ABSTRACT

A safety cutting device for vehicle seat belts, in which the device is attached to the insertable tong of such a seat belt. In this manner, the device is always readily available for use in an emergency such as a crash, fire, or the like.

### BACKGROUND OF THE INVENTION

This invention deals with a safety cutting device for vehicle seat belts, in which the device is attached to the insertable tong of such a seat belt. In this manner, the device is always readily available for use in an emergency such as a crash, fire, or the like.

Generally, in crash situations, it is common for vehicles to overturn and maintain belted occupants in an upside-down position in which the occupant literally hangs from the safety belt. In such a situation, it is common for persons involved to become disoriented and not in control of the situation and therefore, not have the wherewithal to locate a device for releasing the seat belt, especially if it is stored in a compartment of the vehicle away from the belt.

In addition, quite often in vehicle crashes, the seat belt mechanism can become jammed or the occupant does not have ready availability to the release mechanism for the belt.

In all such cases, there is a need for a belt release that is attached directly to the working end of a seat belt so that it is handy and readily available to the seat occupant. In addition, there is a need for a device that is easily useable.

Most of the prior art deals with emergency belt release and one such U.S. Patent is U.S. Pat. No. 9,499,122 issued to Nowak, et al on Nov. 22, 2016 deals with a device for emergency cutting off fastened seatbelts featuring a bushing-shaped housing with an explosive charge or a gas generator inside for releasing a cutting mechanism.

U.S. Pat. No. 10,486,643 that issued to Raybon on Nov. 26, 2019 deals with an emergency escape tool which is a housing mounted on the side of the vehicle seat that contains a slot and a blade in the slot to sever the seat belt.

U.S. Pat. No. 4,680,861 that issued on Jul. 21, 1987 to Meurer deals with a cutter that has a flat body portion containing a protected blade that is set into a slit in the flat body.

### THE INVENTION

Thus, what is claimed and disclosed here is an auto safety belt release. The auto safety belt release comprises a housing, wherein the housing has a bottom portion and a top portion. The bottom portion has located in it, supported by a stanchion, a cutting disc, the cutting disc being centered in the housing.

The bottom portion has two parallel sides, each such side having a bottom edge, each bottom edge turned inward to form a narrow lip. The bottom portion has a first elongated channel above each lip and the bottom portion has two elongated grooves, one such groove on either side of the stanchion.

The housing has a cutting track assembly in the bottom portion, the cutting track having a second elongated channel centered in the cutting track assembly. There are two protrusions in a top surface of the cutting track assembly located on either side of the cutting track, wherein there two v-channels are oppositely opposed to the protrusions. The cutting track is slidably held in the first elongated channels.

The top portion of the auto safety belt release is vertically slidable from said bottom portion of the auto safety belt release. The top portion is detachedly locked to the bottom portion by at least two topical lock pins.

The auto safety belt release is attached to a base, wherein the base has at least four through openings for fasteners to attach the base to a safety belt metal tong.

In another embodiment, there is an auto safety belt release as described Supra, in which the top portion has at least two downwardly directed pegs that insert in openings in a base to lock the auto safety belt release in place.

In yet another embodiment, there is a method of releasing an auto safety belt, the method comprising providing an auto safety belt release device as described just Supra, attached to an auto safety belt, lifting the top portion of the auto safety belt release device, and moving the auto safety belt release device across the auto safety belt.

### BRIEF DESCRIPTIONS OF THE DRAWINGS

FIG. 1 is a full side view of the device of this invention.

FIG. 2 is a full top view of the device of this invention mounted on the end of a safety belt attachment.

FIG. 3 is a full top view of the bottom portion of the device of this invention.

FIG. 4 is a full end view of a device of this invention.

FIG. 5 is a side view of the device of this invention and a seat belt adjacent thereto.

FIG. 6 is a full end view of the top portion of this device.

FIG. 7 is a full view of the arrangement of the cutting wheel of this device and its support in the stanchion.

FIG. 8A is a right side of the arrangement of FIG. 7.

FIG. 8B is a left side of the arrangement of FIG. 7.

### DETAILED DESCRIPTION OF THE DRAWINGS

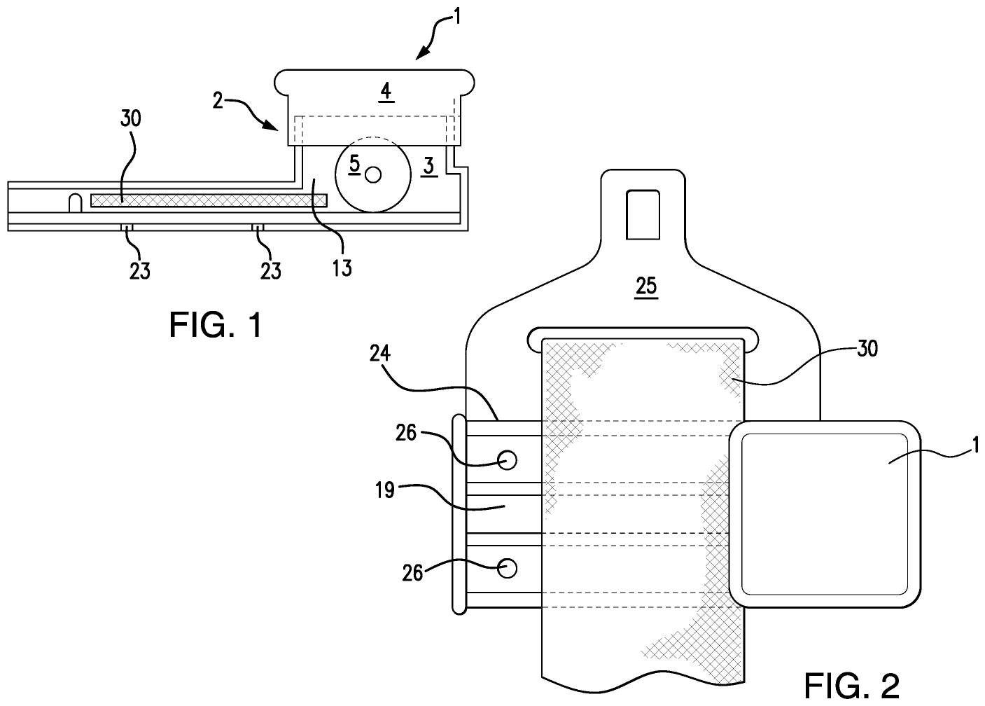

Turning now to FIG. 1 which is a full side view of a device of this invention, which is an auto safety belt release 1, there is a housing 2 comprised of a bottom portion 3 and a top portion 4. The bottom portion 4 has a cutting disc 5 centered therein. With reference to FIGS. 6, 7, 8A and 8B, there is shown the supporting structure 28 for the cutting disc 5 comprised of a stanchion 6 comprised of two halves 7 and 7′. When fit together as shown in FIG. 6, they are held together containing an axle 8, an axle washer bearing mount 9, and a fastener 10 on each side of the cutting disc 5, located on the axle 8. There are two small screw holes 11, one on each side of the disc 5, and a snap fitting 12. The device is held together by threaded bolt 31 (FIG. 8A).

Turning to FIG. 1, there is shown the bottom portion 3 having two sides 13 and 13′ (13′ not shown in this Figure, but is identical to 13, see FIG. 4) wherein each side has a bottom edge 14 (FIG. 4), wherein the bottom edges 14 are turned inward to form a narrow lip 15 and 15′. As can be observed from FIG. 4, the lips 15 and 15′ serve to support the cutting track.

There is an elongated groove 16 and 16′, one on either side of the stanchion 6 and above each lip 15 and 15′. These grooves serve to guide the release 1 as it is move d across the seat belt. In addition, the bottom portion 4 has two v-channels 22 and 22′ oppositely opposed to the protrusions 20 and 20′, one on each side of the stanchion 6 as shown in FIG. 4. These protrusions fit into the v-channels to help guide the release 1 when it is moved across the seat belt.

The housing 2 contains a cutting track assembly 18 in the bottom portion 3. The cutting track assembly 18 has a second elongated channel 19 centered in it to allow for the passage of the cutting disc 5. It has two protrusions 20 and 20′ (FIG. 4) in a top surface 21 of the cutting track assembly 18 located on either side of the cutting track 18. The cutting track assembly 18 is slidably held in the first elongated channels 16 and 16′.

The top portion 4 of the auto safety belt release 1 is vertically slidable from the bottom portion 3 of the auto safety belt release 1. The top portion 4 is detachedly locked to the bottom portion by snap locks 27.

The auto safety belt release 1 is attached to a base 24, wherein the base 24 has at least four through openings 26 for fasteners (not shown) to attach the base 24 to a safety belt metal tong 25 (the tong and safety belt not being part of the instant invention).

In this first embodiment of the instant invention, there is a means of attaching the top portion 4 to the bottom portion 3 which is two topical lock pins 27.

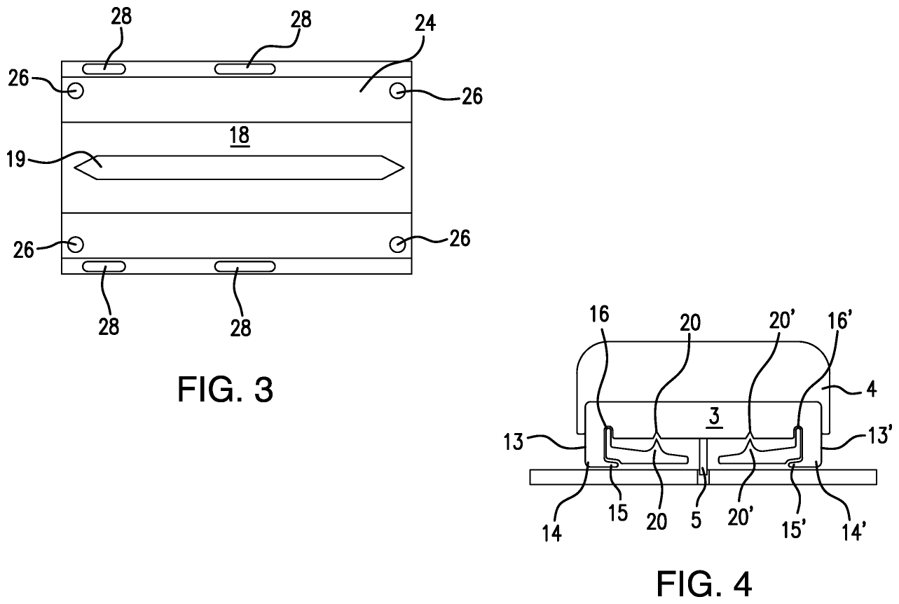

There is a means of retaining the auto safety belt release 1 in the unused position, namely, pegs 23 in cavities 28 as shown in FIG. 3 (pegs shown in FIG. 1).

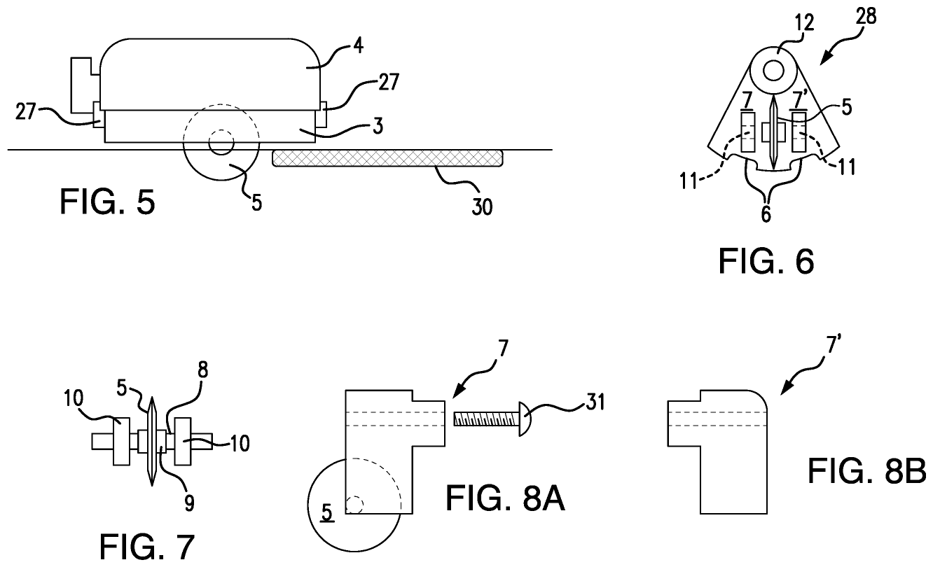

A safety belt 30, which is not part of this invention is shown in FIGS. 1, 2, and 5.

In use, the auto safety belt release is retained in a position adjacent to a safety seat belt and is securely fastened to the seat belt tong 25. In use, the a person lifts the top portion of the auto safety belt release which releases the auto safety belt from the base and allows the auto safety belt release to move across the seat belt wherein the cutting disc 5 cuts through the belt. If necessary, the device can be moved several times in a pull/push fashion across the belt if needed for full release.

What is claimed is:

1. An auto safety belt release, said auto safety belt release comprising:
a housing, said housing having a bottom portion and a top portion, said bottom portion having located therein, supported by a stanchion, a cutting disc, said cutting disc being centered in said housing;
said bottom portion having two parallel sides, each said side having a bottom edge, each bottom edge turned inward to form a narrow lip, said bottom portion having a first elongated channel above each said lip;
said bottom portion having elongated grooves, one such groove on either side of said stanchion;
said housing having a cutting track assembly in said bottom portion, said cutting track having a second elongated channel centered in said cutting track assembly, there being two protrusions in a top surface of said cutting track assembly located on either side of said cutting track, there being two v-channels oppositely opposed to said protrusions, said cutting track being slidably held in said first elongated channels;
said top portion of said auto safety belt release being vertically slidable on said bottom portion of said auto safety belt release, said top portion being detachedly locked to said bottom portion by at least two topical lock pins;
said auto safety belt release attached to a base, said base having at least four through openings for fasteners to attach said base to a safety belt metal tong.

2. The auto safety belt release as claimed in claim 1 wherein, in addition, the said top portion has at least two downwardly directed pegs that insert in concavities in a base to retain said auto safety belt release in place.

3. A method of releasing an auto safety belt, the method comprising providing an auto safety belt release device as claimed in claim 1, attached to an auto safety belt;
lifting said top portion of said auto safety belt release device;
moving said auto safety belt release across said auto safety belt.

4. A method of releasing an auto safety belt, the method comprising providing an auto safety belt release device as claimed in claim 2, attached to an auto safety belt;
lifting said top portion of said auto safety belt release device;
moving said auto safety belt release across said auto safety belt.
